(19) United States
(12) Patent Application Publication
(10) Pub. No.: US 2013/0298695 A1
(43) Pub. Date: Nov. 14, 2013

(54) MEASURING DEVICE WITH A FLUID METER

(71) Applicant: SENSUS SPECTRUM LLC, Raleigh, NC (US)

(72) Inventors: Holger KUHLEMANN, Sarstedt (DE); Mark FRISTER, Hannover (DE)

(73) Assignee: Sensus Spectrum LLC, Raleigh, NC (US)

(21) Appl. No.: 13/890,843

(22) Filed: May 9, 2013

(30) Foreign Application Priority Data
May 9, 2012 (DE) DE102012009076.5

(51) Int. Cl. G01F 1/00

(52) U.S. Cl. CPC G01F 1/00
USPC 73/861

(57) ABSTRACT

A measuring device is provided that includes a fluid meter for determination of the flow rate of a fluid flowing through a measuring tube, at least one measuring unit for detecting physical, chemical or biological properties of the fluid, at least one evaluation unit for evaluation of the data captured by means of the measuring unit, and at least one communication unit, wherein the measuring unit, evaluation unit and communication unit are designed as one or more individual modules and each individual module can be connected mechanically to the fluid meter.

This nonprovisional application claims priority under 35 U.S.C. §119(a) to German Patent Application No. DE 10 2012 009 076.5, which was filed in Germany on May 9, 2012, and which is herein incorporated by reference.

### BACKGROUND OF THE INVENTION

1. Field of the Invention

The present invention relates to a measuring device with a fluid meter, at least one measuring unit for detecting physical, chemical or biological properties of the fluid, at least one evaluation unit for evaluation of the data captured by means of the measuring unit and at least one communication unit.

2. Description of the Background Art

By means of a multiplicity of different techniques, previously known fluid meters give information concerning quantity of fluid flowing through a pipe section per unit of time.

Thus for example when municipalities are supplied with drinking water so-called bulk water meters are used as fluid meters in order to determine the flow rate of a fluid flowing through a measuring tube.

However, when municipalities are supplied with drinking water there is a requirement not only for information relating to the quantity of drinking water supplied but also for information with regard to the quality of the drinking water supplied.

For this purpose samples of drinking water are usually taken which are analyzed in the laboratory. This method is associated with high staffing costs and thus is comparatively expensive. As a result the measurement intervals for determination of the quality of the drinking water are generally very great and changes in the quality of the drinking water are only detected with a substantial time lag.

It is desirable to provide a device in which changes in the quality of the fluid flowing through a pipe, such as for instance drinking water, are detected quickly and reliably.

### SUMMARY OF THE INVENTION

It is therefore an object of the present invention to provide a compact and versatile device which makes it possible to obtain information quickly and reliably about physical, chemical or biological properties of a fluid flowing through a pipe.

According to an embodiment of the invention this object is achieved by a measuring device comprising a fluid meter for determination of the flow rate of a fluid flowing through a measuring tube, at least one measuring unit for detecting physical, chemical or biological properties of the fluid, at least one evaluation unit for evaluation of the data captured by means of the measuring unit, and at least one communication unit, wherein the units consisting of measuring unit, evaluation unit and communication unit are designed as one or more individual modules and each individual module can be connected mechanically to the fluid meter.

Within the context of the invention “fluid” can be understood to mean both liquids and gases.

The invention has the advantage that, at one single generally already existing measuring location in a pipe section, in addition to the determination of the flow rate of the fluid through the pipe section it is possible to determine a plurality of fluid-related variables such as for instance temperature, pH value, pressure, nitrate or chlorine content or micro-organisms. Since all the units necessary for the capture and evaluation of the metering data are contained in modular form in the measuring device according to the invention, the measuring device can be used in a comparatively compact and simple manner.

The modular construction of the measuring device enables a flexible use of the measuring device, so that depending upon the application one or more required fluid-related variables can be determined.

In an embodiment the connection between the fluid meter and the individual module is designed to be releasable, so that for example one module can be replaced by another one, so that the measuring device according to the invention can be used cost-effectively in a large number of applications.

The individual modules and the fluid meter can be connectable to one another electrically and/or acoustically, so that they can communicate with one another. In addition or alternatively a visual communication may be provided.

For remote reading of the captured data it is advantageous that the communication unit comprises a data transmission unit for remote transmission of data. In this way it is possible for example for fluctuations in the quality of the fluid which are detected by the measuring unit to be recognized rapidly and reliably.

Furthermore it is advantageous that a control unit is provided. This control unit can be used for example in order to relay control signals to valve parts. In particular the control unit can be used in order to actuate a stopcock or pusher when the measuring unit has determined a value which is above an acceptable limit. In this case it is advantageous that the control unit is constructed as an individual module which can be mechanically connected to the fluid meter.

For fixing the fluid meter on a pipe section it is advantageous that a holding device is provided to receive the fluid meter.

In an embodiment at least one individual module is disposed on the holding device. In this case the holding device can be constructed for example as a band or as a link articulation or also in the form of a shell, in particular in the form of a half-shell.

Alternatively the fluid meter can have at least one receiving device to receive an individual module. Thus for example the fluid meter can have a housing on the outside of which is disposed at least one receiving device to receive an individual module.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a measuring device according to a first embodiment on a pipe section,

FIG. 2 shows a holding device according to the first embodiment,

FIG. 3 shows the fluid meter and individual modules according to the first embodiment,

FIG. 4 shows a second embodiment of a measuring device,

FIG. 5 shows a third embodiment of a measuring device in plan view,

FIG. 6 shows the embodiment illustrated in FIG. 5 from below,

FIG. 7 shows a fourth embodiment of the present invention in a perspective view,

FIG. 8 shows the embodiment illustrated in FIG. 7 before fitting on a pipe section.

### DETAILED DESCRIPTION

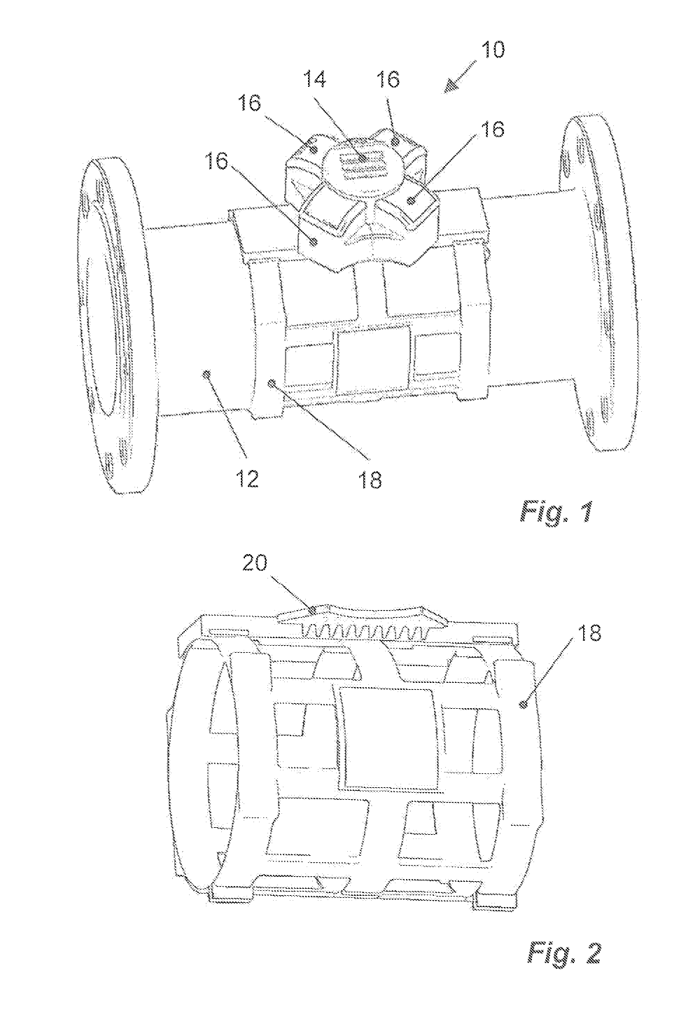

FIG. 1 shows a first embodiment of a measuring device 10 on a pipe section constructed as a measuring tube 12. The measuring device 10 comprises a fluid meter 14 and a plurality of individual modules 16 which are disposed in a circular manner around the fluid meter 14. The fluid meter 14 is fastened on a holding device 18.

As can be seen best in FIG. 2, the holding device 18 is constructed substantially like a sleeve and wraps around the pipe section 12. A support plate 20 on which the fluid meter 14 can be fastened on the outer face of the holding device 18.

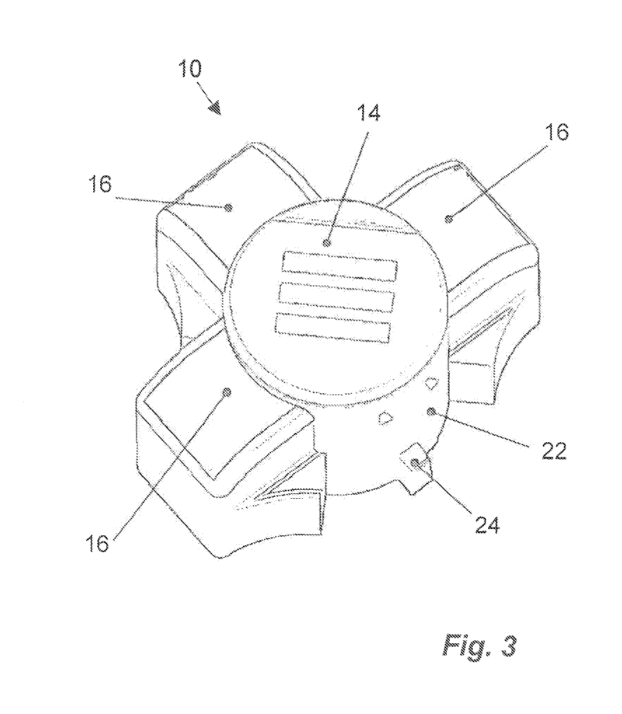

FIG. 3 shows the fluid meter 14 and three individual modules 16. Each individual module 16 has its own function. The illustrated individual modules 16 for example represent three of the following: a module with a measuring unit for detecting physical, chemical or biological characteristics of the fluid, a module with an evaluation unit for evaluation of the data captured by means of the measuring unit, a module with a communication unit for indicating and/or transferring the captured and/or the evaluated data, a module with a control unit for controlling valve parts or a module with a battery unit, wherein individual ones of the said units can also be combined in a common module.

The fluid meter 14 has a housing 22 on which a receiving device 24 is disposed in the form of positive-locking connecting elements to releasably receive the individual modules 16.

The individual modules 16 and the fluid meter 14 are connected to one another electrically and/or acoustically for communication with one another. Although this is not illustrated, the communication of the individual modules 16 with one another and with the fluid meter 14 can in addition or alternatively take place optically.

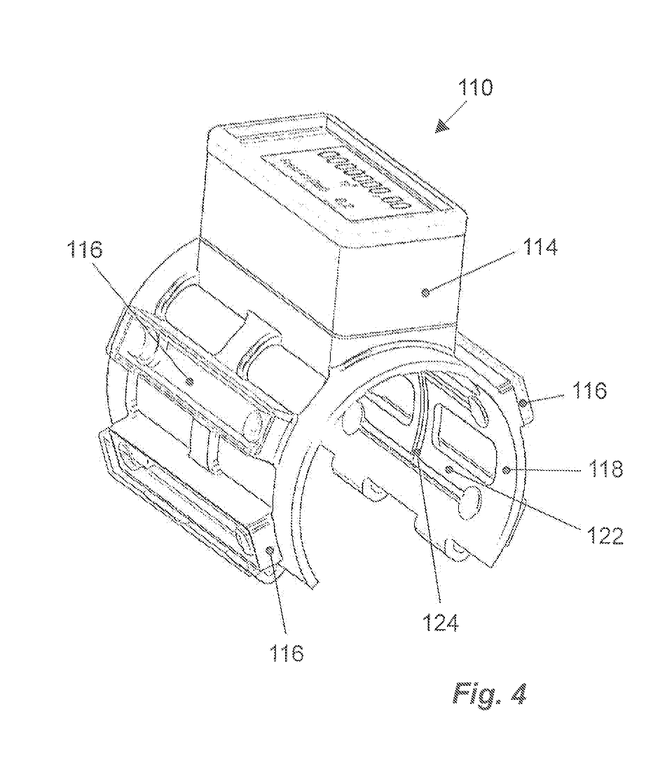

FIG. 4 shows a second embodiment of a measuring device 110. The fluid meter 114 is connected to a clamp-like holding device 118 in the form of a half-shell. The holding device 118 in the form of a half-shell can be fitted onto a pipe section. The holding device 118 comprises longitudinal ribs 122 which extend in the axial direction and on which individual module 116 are releasably disposed. Electrical connections 124 which enable a communication of the individual modules 116 with one other and with the fluid meter 114 are provided on the inner face of the holder 118. The construction and the function of the individual modules 116 correspond substantially to the construction and the function of the individual modules described in connection with FIG. 3.

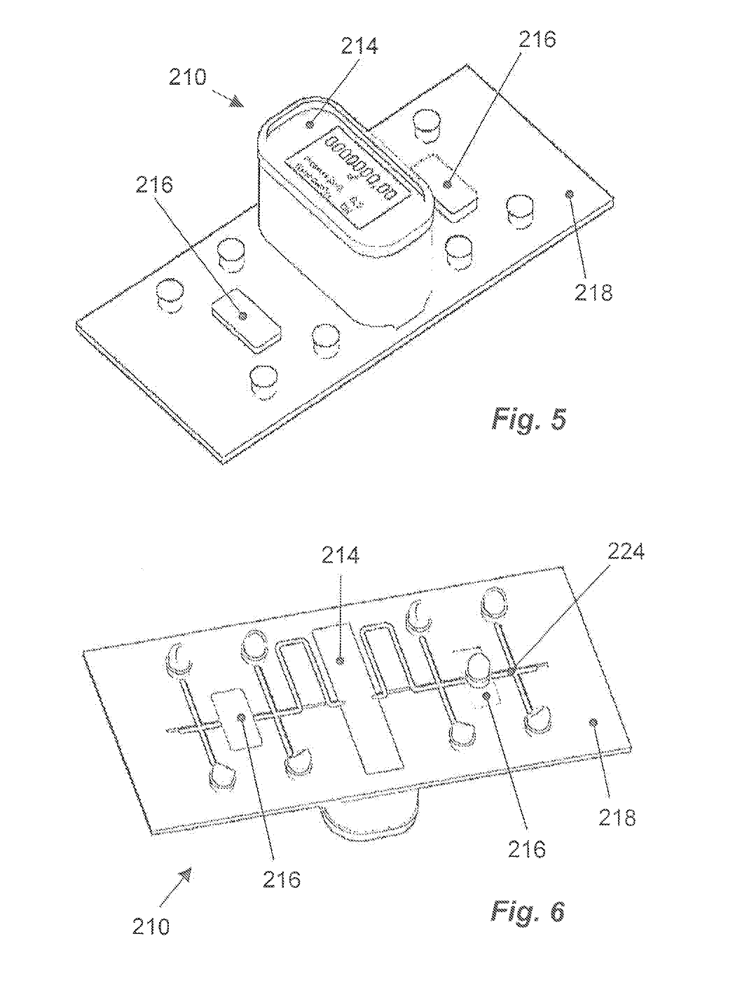

A third embodiment of the measuring device 210 is illustrated in FIG. 5. The holding device 218 is constructed as an elastic band on which the fluid meter 214 and the individual modules 216 are disposed. As FIG. 6 shows, the individual modules 216 are connected by means of electric connections 224 to one another and to the fluid meter 214 on the underside of the holding device 218 so that they can communicate with one another. The individual modules 216, which have substantially the same construction as the individual modules 16, 116 already illustrated, are firmly connected to the elastic band. In an alternative embodiment (not shown) the individual modules 216 are releasably connected to the elastic band.

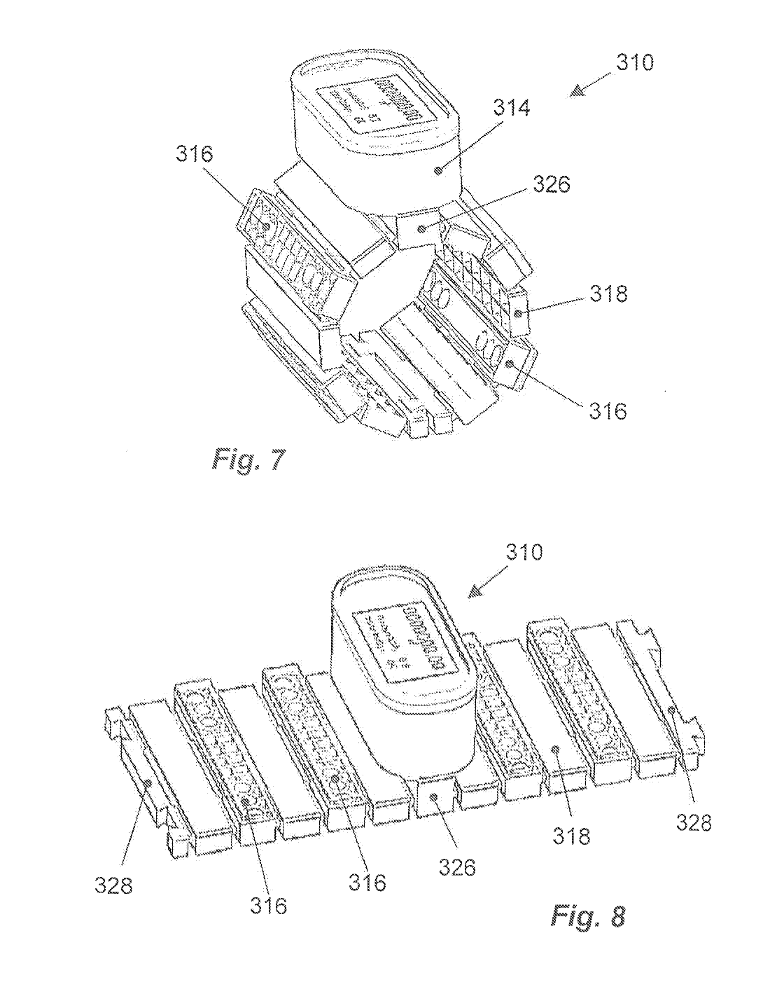

A fourth embodiment of a measuring device 310 is illustrated in FIG. 7. In this embodiment the holding device 318 is constructed as a link band. One or more of the links can be constructed as individual modules 316 which are either mechanically connected directly to one another or are mechanically connected to one another by means of spacing links and communicate with one another by means of electric connections.

The fluid meter 314 is fastened on a chain link 326.

As FIG. 8 shows in particular, a closure 328 is provided in order to fasten the holding device 318 on a pipe section.

The links can be connected to one another in any way so that depending upon the use of the measuring device 310 the desired modules 316 can be combined.

It is a common feature of all embodiments that they comprise a fluid meter 14, 114, 214, 314 which is connected electrically and/or acoustically to the individual modules 16, 116, 216, 316, so that the individual modules 16, 116, 216, 316 and/or the fluid meter 14, 114, 214, 314 communicate with one another. In this case the individual modules 16, 116, 216, 316 have different functions and can be combined with one another or interchanged according to the purpose for which they are to be used.

In an exemplary embodiment of the illustrated measuring devices 10, 110, 210, 310 these devices comprise a fluid meter 14, 114, 214, 314 and a measuring unit for detecting physical, chemical or biological properties of the fluid, an evaluation unit for evaluation of data captured by means of the measuring unit, a communication unit and a control unit, wherein the measuring unit, the evaluation unit, the communication unit and the control unit are constructed as individual modules 16, 116, 216, 316 and communicate electrically with one another and with the fluid meter. Alternatively the individual modules 16, 116, 216, 316 and the fluid meter 14, 114, 214, 314 communicate acoustically with one another.

The fluid meter 14, 114, 214, 314 determines the flow rate of a fluid such as for instance drinking water through a pipe section. With the aid of the aid the measuring unit for detecting physical, chemical or biological properties of the fluid a fluid-related variable, such as for instance temperature, pH value or also the concentration of different substances such as for instance nitrate, lead and fluorine, can be determined and can be evaluated by means of the evaluation unit. The communication unit indicates the data captured by the fluid meter and by the measuring unit and/or indicates the data evaluated by the evaluation unit, wherein the communication unit has a data transmission unit in order to transfer the captured and/or evaluated data by means of remote transmission to a remote readout station. A control signal is relayed with the aid of the control unit in order for example to close a valve in the pipe section when the measured value captured by the measuring unit exceeds a predetermined threshold value.

In an alternative embodiment no control unit and no data transmission unit are provided.

A plurality of different parameters of the fluid can be determined with the aid of one or more individual modules designed as a measuring unit. For example an individual module designed as a measuring unit may be adapted to determine the pressure, the temperature, the pH value of the water or also the concentration of different substances such as for instance nitrate, lead, fluorine, etc. A combination of a plurality of measuring units in a measuring device enables the simultaneous determination of a plurality of different parameters of the fluid.

If in the illustrated embodiment the individual modules are generally releasably connected to the holding device, then it is also within the context of the invention if several or all individual modules of a measuring device are firmly connected to the holding device.

In an embodiment of a measuring device which is not shown, a holding device is provided to receive the fluid meter, wherein the individual modules are releasably disposed both in a receiving device on the housing of the fluid meter and on the holding device and communicate by means of electrical or acoustic connections with one other and with the fluid meter.

The measuring device according to the invention is suitable in particular for the determination of the flow rate and the quality of drinking water through a supply line for example of a municipality using a bulk water meter as fluid meter.

However, the measuring device according to the invention can also be used in the determination of flow rates and quality parameters of different fluids using any type of fluid meter.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A measuring device comprising:
a fluid meter configured to determine a flow rate of a fluid flowing through a measuring tube;
at least one measuring unit configured to detect physical, chemical or biological properties of the fluid;
at least one evaluation unit configured to evaluate the data captured via the measuring unit; and
at least one communication unit,
wherein the measuring unit, evaluation unit and communication unit are constructed as one or more individual modules and these individual modules are mechanically connectable to the fluid meter.

2. The measuring device as claimed in claim 1, wherein the connection between the fluid meter and the individual modules is releasable.

3. The measuring device as claimed in claim 1, wherein the individual module and the fluid meter communicate electrically and/or acoustically with one another.

4. The measuring device as claimed in claim 1, wherein the communication unit comprises a data transmission unit for remote transmission of data.

5. The measuring device as claimed in claim 1, wherein a control unit is provided.

6. The measuring device as claimed in claim 5, wherein the control unit is constructed as an individual module, which is mechanically connectable to the fluid meter.

7. The measuring device as claimed in claim 1, wherein a holding device is adapted to receive the fluid meter.

8. The measuring device as claimed in claim 7, wherein at least one individual module is arranged on the holding device.

9. The measuring device as claimed in claim 7, wherein the holding device is constructed as a band or as a link articulation.

10. The measuring device as claimed in claim 7, wherein the holding device is constructed in the form of a shell, in particular in the form of a half-shell.

11. The measuring device as claimed in claim 1, wherein the fluid meter has at least one receiving device to receive an individual module.

12. The measuring device as claimed in claim 11, wherein the fluid meter has a housing on an outside of which is arranged at least one receiving device to receive an individual module.
